(19) United States
(12) Patent Application Publication
(10) Pub. No.: US 2015/0269120 A1
(43) Pub. Date: Sep. 24, 2015

(54) MODEL PARAMETER CALCULATION DEVICE, MODEL PARAMETER CALCULATING METHOD AND NON-TRANSITORY COMPUTER READABLE MEDIUM

(71) Applicant: KABUSHIKI KAISHA TOSHIBA, Minato-ku (JP)

(72) Inventors: Minoru NAKATSUGAWA, Yokohama (JP); Takeichiro NISHIKAWA, Yokohama (JP)

(73) Assignee: KABUSHIKI KAISHA TOSHIBA, Minato-ku (JP)

(21) Appl. No.: 14/659,922

(22) Filed: Mar. 17, 2015

(30) Foreign Application Priority Data
Mar. 20, 2014 (JP) 2014-059031

(51) Int. Cl. G06F 17/10; G06F 17/50

(52) U.S. Cl. CPC G06F 17/10; G06F 17/5009

(57) ABSTRACT

In a model parameter calculation device, the comparator compares a first evaluation value calculated from a first model and operating data on a terminal device with a second evaluation value calculated from a second model and the operating data. The requester transmits an inspection request to inspect the terminal device to the terminal device or a management device thereof in accordance with a comparative relation between the first evaluation value and the second evaluation value. The parameter determiner determines a third parameter included in a third model in accordance with a model reference of a predefined model type, on basis of an inspection result indicating an operating status of the terminal device and the operating data of the terminal device, wherein the third model associates the third parameter with a third output variable regarding the occurrence possibility of the failure in the terminal device.

### CROSS-REFERENCE TO RELATED APPLICATIONS

This application is based upon and claims the benefit of priority from Japanese Patent Application No. 2014-059031, filed Mar. 20, 2014; the entire contents of which are incorporated herein by reference.

### FIELD

Embodiments of the present invention relate to a model parameter calculation device, a model parameter calculating method and a non-transitory computer readable medium.

### BACKGROUND

A learning method called an active learning method is known. In this learning method, a model with high prediction accuracy is learned by selectively obtaining a small number of supervised signals. Specifically, data for which a result is already known is used as training data, and data for which a result is not known yet is used as prediction data. By doing so, the model is learned. This is a method that enables highly accurate prediction with a small number of pieces of data and that has an exceedingly wide range of application.

Using the active learning method, a model for detecting future failure occurrence in a hard disk drive (HDD) from operating data of the HDD (failure symptom detecting model) can be constructed. As data for learning the model, operating history data on a failure HDD and an operating HDD is used. Analyzing this learning data allows the failure symptom detecting model to be constructed. According to the failure symptom detecting model, a probability that a failure occurs within a predetermined period is calculated. When the probability is equal to or greater than a threshold, the presence of a failure symptom can be determined.

In this case, appearance of a new machine type in a new generation or a similar status needs generation of a failure symptom detecting model for the new machine type. This is because the change in machine type changes a status of the failure and the content of internal information of the HDD. Generation of a model compatible with the new machine type needs operating history data of failure HDDs of the new machine type. However, it takes time for the new machine type to accumulate a sufficient number of pieces of data for the model generation. Usage of a model generated from an insufficient number of pieces of the data may cause occurrence of overlooking and/or misdetection. The overlooking means that a failure occurs within a predetermined period in spite of a prediction result indicating the absence of a failure symptom. The misdetection means that a failure does not occur within the predetermined period in spite of a prediction result indicating the presence of a failure symptom.

### BRIEF DESCRIPTION OF THE DRAWINGS

FIG. 1 is an overall block diagram of a system in which a model parameter calculation device and terminal devices according to a first embodiment are connected to one another via a network;

FIG. 2 is a functional block diagram of the model parameter calculation device and each of the terminals;

FIG. 3 illustrates an example of operating data;

FIGS. 4A and 4B illustrate examples of pre-update parameters and post-update parameters;

FIG. 5 illustrates an example of a machine type ID table;

FIG. 6 illustrates an example of a training data table;

FIG. 7 illustrates an example of a detection result table;

FIG. 8 is a flowchart of a selection method of a sample terminal;

FIG. 9 is a flowchart of operation of a requester;

FIG. 10 illustrates an example of a hardware configuration of the terminal;

FIG. 11 illustrates an example of a hardware configuration of the model parameter calculation device;

FIG. 12 is an operation flowchart of the model parameter calculation device according to the first embodiment;

FIG. 13 is a block diagram of a variation of the model parameter calculation device and the terminal device according to the first embodiment;

FIG. 14 illustrates a variation of the network configuration according to the first embodiment;

FIG. 15 illustrates a lot ID table;

FIG. 16 is an operation flowchart of a model parameter calculation device according to a third embodiment;

FIG. 17 illustrates probability distributions “P” and “Q”;

FIG. 18 is an operation flowchart of a model parameter calculation device according to a fourth embodiment; and

FIG. 19 illustrates a relation between operating data and features.

### DETAILED DESCRIPTION

According to one embodiment, a model parameter calculation device including a processor includes a comparator, a requester and a parameter determiner.

The comparator compares a first evaluation value with a second evaluation value.

The first evaluation is calculated on basis of a first model and operating data on a terminal device, the first model represents relationship between at least one first parameter including at least one first variable and a first output variable regarding an occurrence possibility of a failure in the terminal device, the first variable being allocated with at least one feature based on operating data of the terminal device.

The second evaluation value is calculated on basis of a second model and the operating data, the second model represents relationship between at least one second parameter including at least one second variable and a second output variable regarding the occurrence possibility of the failure in the terminal device, the second parameter being allocated with at least one feature based on the operating data.

The requester transmits an inspection request to inspect the terminal device to the terminal device or to a management device of the terminal device in accordance with a comparative relation between the first evaluation value and the second evaluation value.

The parameter determiner determines at least one third parameter included in a third model in accordance with a model reference of a predefined model type, on basis of an inspection result indicating an operating status of the terminal device and the operating data of the terminal device, wherein the third model represents relationship between the third parameter and a third output variable regarding the occurrence possibility of the failure in the terminal device, the third parameter includes at least one third variable being allocated with at least one feature based on the operating data.

Hereafter, embodiments of the present invention are described with reference to the drawings.

### First Embodiment

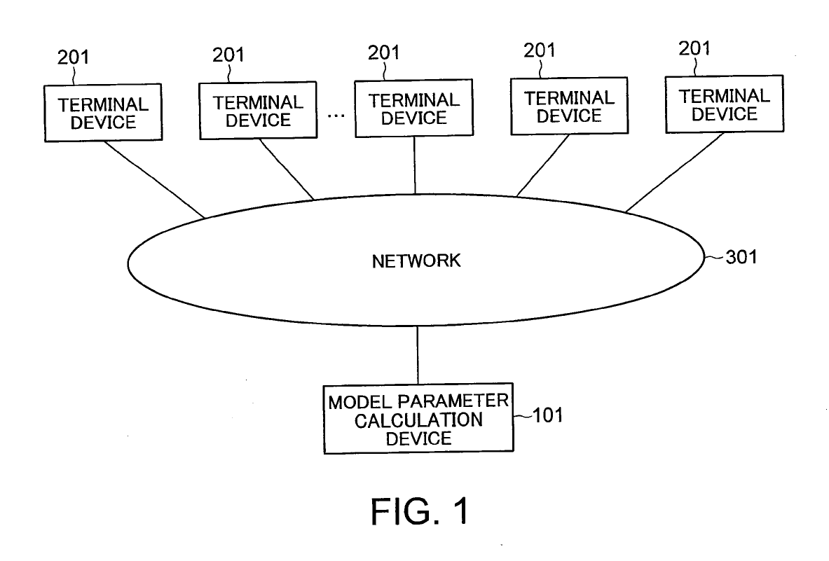

FIG. 1 is a diagram illustrating a model parameter calculation device according to a first embodiment and terminal devices (hereinafter referred to as terminals) communicating with the model parameter calculation device.

A model parameter calculation device 101 and terminals 201 are connected to one another via a network 301. The network 301 is a wireless network, a wired network or a hybrid network of these. The network 301 may be a local area network or a wide area network such as the Internet.

The terminal 201 is a user terminal such as a personal computer (PC), a tablet, a smart phone and a portable terminal. The terminal includes elements included in a typical computer, circuitry such as a CPU or a processor, a memory, an external storage device, an input, a display and a communicator. Examples of the external storage device include an HDD, an SSD, an SD card and the like. Each terminal 201 acquires operating data indicating an operating status of its own device and records it inside. Examples of the operating data include, for example, a sensor data log of components such as the HDD and the CPU and similar data.

Each terminal 201 has two failure symptom detecting models for detecting a failure symptom of the terminal (hereinafter referred to as models). One of these is called a pre-update model and the other a post-update model. In the embodiment, models for detecting the failure symptom of the HDD are supposed as such models. The model evaluates a probability in which the HDD suffers the failure within a predetermined period. The terminal performs failure symptom detection of the HDD on basis of each model. Specifically, the terminal calculates values representing an occurrence possibility of the failure in the HDD on basis of the respective models and the operating data. The calculated values are set as failure symptom detection results (hereinafter referred to as detection results). The terminal uses, as the detection result of its own device, the detection result obtained using the post-update model out of the two models. For example, when the value of the post-update model is equal to or greater than a threshold, the presence of the failure symptom (that the HDD possibly suffers the failure within the predetermined period) is determined. In this case, the status may be reported to the user. A massage for prompting exchange of the HDD or the terminal or similar action may also be reported thereto.

The model parameter calculation device 101 is a server communicating with the terminals 201 and a service carrier-side device. The model parameter calculation device 101. receives the detection results of the pre-update model and the post-update model from each terminal. Moreover, the model parameter calculation device 101 collects the operating data from each terminal. The model parameter calculation device 101 compares the detection results of the pre-update model and the post-update model with each other. In accordance with a comparison result, it selects the relevant terminal as a sample terminal for which inspection of the HDD is performed and transmits an inspection request of the HDD to the selected terminal. The model parameter calculation device 101 receives an inspection result from the terminal to which the inspection is requested. Setting the inspection result of each terminal as training data, a model is generated for each machine type of the terminal on basis of the operating data of each terminal. Generation of the model is performed by determining a model parameter in accordance with a model reference of a predefined model type. Herein, the model type is a type of the model, such as a logistic regression model, a support vector machine and a decision tree model. The model reference is a reference (function or the like) used for generating the model, a value of the reference is an index for evaluating excellence of the generated model. The model parameter calculation device 101 distributes the generated model (determined parameter; model type) to the terminals of a relevant machine type. The terminal sets the model currently distributed from the model parameter calculation device 101 as the post-update model and replaces the pre-update model by the previous post-update model. Repeating the processing above allows the post-update model to converge and improves model accuracy. Accordingly, a model high in accuracy can be quickly generated without waiting for accumulation of operating history data of failure HDDs.

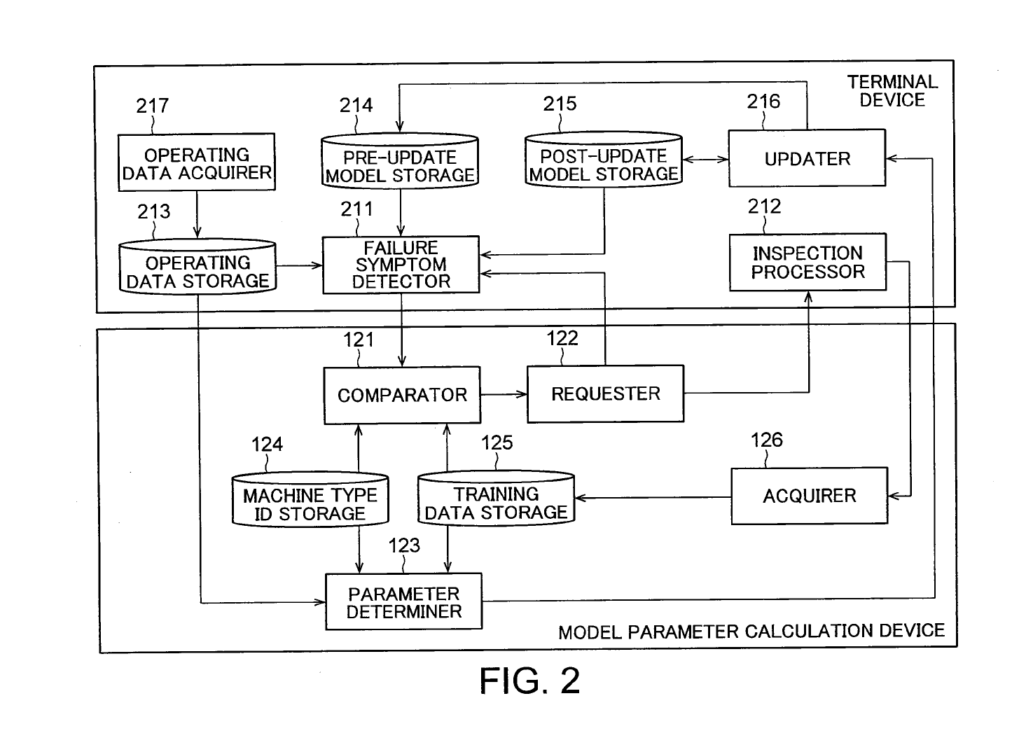

FIG. 2 illustrates functional blocks of the model parameter calculation device 101 and the terminal 201. Each line connecting the blocks in the devices indicates a flow of information or control. Moreover, each line connecting the blocks between the terminal and the model parameter calculation device does not indicate an actual solid wiring but simply represents relation of input/output of information between the blocks.

The terminal 201 includes a failure symptom detector 211, an inspection processor 212, an operating data storage 213, a pre-update model storage 214, a post-update model storage 215, an updater 216 and an operating data acquirer 217.

The operating data acquirer 217 acquires the operating data of the terminal by executing a predetermined collection program. The operating data acquirer 217 is connected to the operating data storage 213 and stores the acquired operating data in the operating data storage 213. The operating data storage 213 stores a history of the operating data acquired by the operating data acquirer 217. The operating data indicates the operating status of the terminal and includes sensor log data of components such as the HDD and the CPU. In addition to this, it includes a “product ID” (serial number) of the HDD and acquisition time (observation time) of the operating data. Examples of the sensor log data of the HDD include, for example, S.M.A.R.T. of the HDD and the like. As other components, for example, data such as a temperature of the CPU and manipulation times of buttons (input) may be included therein.

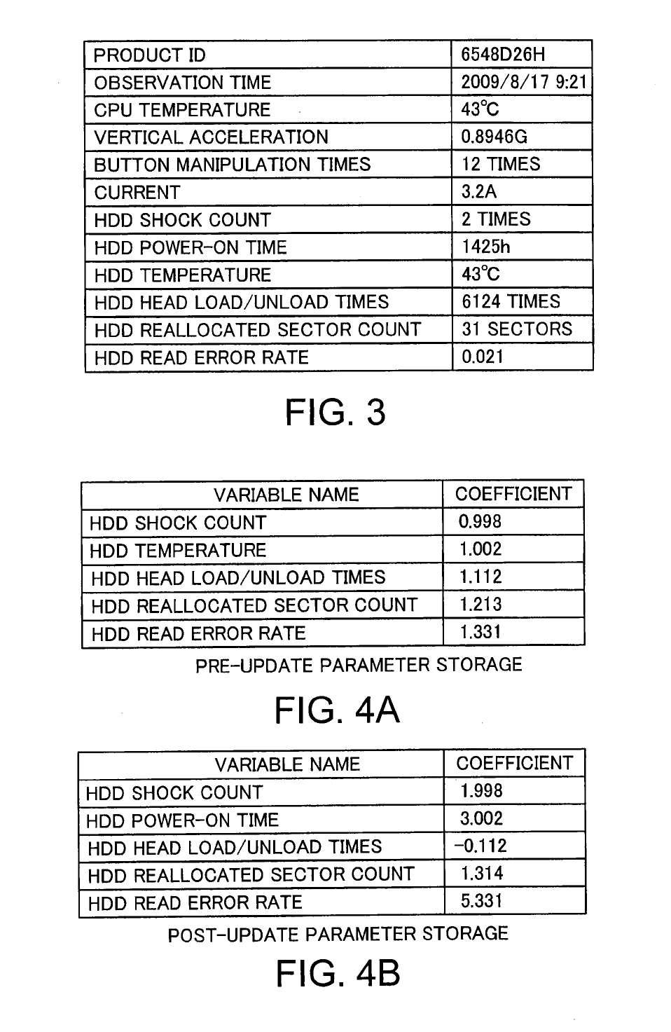

An example of the operating data is illustrated in FIG. 3. The operating data in the figure is acquired data for one time. Such data is stored in the operating data storage 213 in time series. According to elapse of time, the date is sequentially accumulated. Acquisition timing of the operating data may arise at a constant time interval. Otherwise, it may be arbitrarily determined to arise as timing in initializing/terminating the terminal, timing when a specific event takes place, and similar timing.

The post-update model storage 215 stores the newest model (model parameter; model type) provided by the model parameter calculation device. The pre-update model storage 214 stores the model (model parameter; model type) previously provided by the model parameter calculation device. It should be noted that, in an initial state, each of the pre-update model storage 214 and the post-update model storage 215 stores an initial model (initial model parameter; model type).

The updater 216 is connected to the post-update model storage 215 and the pre-update model storage 214. When the model (model parameter; model type) is provided from the model parameter calculation device, the updater 216 reads out the model (parameter; model type) in the post-update model storage 215 and overwrites it to the pre-update model storage 214. Then, the updater 216 overwrites the model (model parameter; model type) provided from the model parameter calculation device into the post-update model storage 215.

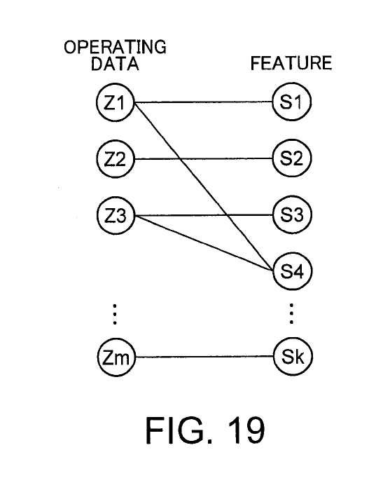

Herein, details of the model parameter are described. The model parameter includes plural variables and coefficients. The coefficients may include a coefficient present as a constant term other than those by which the variables are multiplied. To the variables, features which are values based on the operating data are allocated. Examples of the features include, a newest value of the operating data, a value having the value of the operating data processed, and the like. Examples of that processed includes a value obtained by conversion processing such as logarithmic conversion, a calculation value based on plural values in the operating data, a calculation value obtained among the operating data with plural dates and times (average, median, maximum, minimum, maximum of differences or the like), and the like. Relation between the operating data and the features is schematically illustrated in FIG. 19. Signs “z₁”, “z₂” . . . “zₘ” represent values of items in the operating data. Signs “s₁”, “s₂” . . . “sₖ” represent features calculated from the operating data. For example, “s₁” is a value of an item “z₁” in the operating data, and “s₄” is a value calculated from items “z₁” and “z₃” in the operating data. In this way, the features are calculated from the operating data.

As mentioned above, each of the pre-update model storage 214 and the post-update model storage 215 stores the initial model (initial model parameter; model type) in the initial state. The initial model of the pre-update model storage 214 is, by way of example, a model generated on basis of the operating data of the terminal in which the HDD of an old machine type is implemented. Such a model is generated from data with sufficient samples and has high prediction accuracy for the HDD of the old machine type. Nevertheless, the model possibly only attains low prediction accuracy for the HDD of a new machine type.

Meanwhile, the initial model of the post-update model storage 215 is, by way of example, generated on basis of the operating data of the terminal in which the HDD of the same machine type as that of its own device is implemented. For example, it may be generated on basis of the operating data of the HDD which is the HDD of the same machine type (new model number) and first suffers the failure. In this case, since it is a model generated from a small number of samples, the model is estimated only to attain low prediction accuracy.

The initial models mentioned here are exemplary with no limitation to these. For example, the initial model of the pre-update model storage 214 may be based on the operating data of the terminal in which the HDD of the newest machine type different from that of its own device is implemented.

Here, a few examples of the models are represented. An formula (1) below represents the logistic regression model. A form of the formula represents the model type itself. The formula includes the variables “x₁” . . . “xₖ” and the coefficients “a₀” . . . “aₖ”, as the model parameter. The coefficient “a₀” is also called a constant term. To the variables, as mentioned above, the features based on the operating data are allocated. The coefficients are arbitrary real numbers. “P” is an output variable. A value of the output variable calculated from the formula (1) is an evaluation value. In the case of the logistic regression model, the evaluation value is a failure probability. “P” takes a value larger than “0” and smaller than “1”. “P” is a value representing an occurrence possibility of the failure. The larger the value of “P” is, the larger it is meant that the probability of the failure within the predetermined period is. When the value of “P” is equal to or greater than a threshold, the presence of the failure symptom may be determined, and when it is less than the threshold, the absence of the failure symptom may be determined. While the predetermined period is arbitrarily defined, for example, it may be a certain period from a current time, may be a period to a predefined next terminal replacement time, or may be a period defined otherwise.

### [Formula 1]

$$P = \frac{1}{1 + exp ( {a}_{0} + {a}_{1} {x}_{1} + {a}_{2} {x}_{2} + … + {a}_{k} {x}_{k} )} \qquad formula ( 1 )$$

Moreover, in accordance with the value of the failure probability “P”, a failure symptom rank may be calculated. For example, when P>α, it represents “dangerous”, when α≧p>β, it represents “cautioned”, and when P≧β, it represents “normal”. In this case, the failure symptom rank corresponds to the evaluation value.

FIG. 4A illustrates an example of pre-update parameters. FIG. 4B illustrates an example of post-update parameters. Each of these includes five variables and shares the variables of the same kinds (variable names). Herein, the variable names are “HDD shock count”, “HDD temperature”, “HDD head load/unload times”, “HDD reallocated sector count” and “HDD read error rate”. They respectively correspond to the variables “x₁”, “x₂”, “x₃”, “x₄” and “x₅” in the formula (1). In this example, they all correspond to the items in of the operating data illustrated in FIG. 3. Moreover, the coefficients of the pre-update parameter are “0.998”, “1.002”, “1.112”, “1.213” and “1.331” and correspond to “a₁”, “a₂”, “a₃”, “a₄” and “a₅” in the formula (1). Moreover, the coefficients of the post-update parameters are “1.998”, “3.002”, “−0.112”, “1.314” and “5.331” and correspond to “a₁”, “a₂”, “a₃”, “a₄” and “a₅” in the formula (1). While the numbers of variables coincide with each other in the examples of FIG. 4A and FIG. 4B, different variables may be used for each of those.

Examples of the models other than the logistic regression model include the support vector machine, the linear discriminant analysis model and the like. In these cases, each of the models can be represented by an formula (2) below.

[Formula 2]

y=α₀+α₁x₁+α₂x₂+ . . . +αₖxₖ formula (2)

The variables “x₁” . . . “xₖ” and the coefficients “a₀” . . . “aₖ” are similarly to the formula (1). Term “y” is the output variable. The value of the output variable calculated from the formula (2) is the evaluation value. In the case of each of these models, the evaluation value, that is, the value of “y” indicates the occurrence possibility of the failure. Setting a threshold, when the value of “y” is equal to or greater than the threshold, the presence of the failure symptom can be determined, and when it is less than the threshold, the absence of the failure symptom can be determined. For example, when y≧0, the presence of the failure symptom is determined, and when y<0, the absence of the failure symptom is determined.

The failure symptom detector 211 is connected to the operating data storage 213, the pre-update model storage 214 and the post-update model storage 215. The failure symptom detector 211 calculates the value representing the occurrence possibility of the failure from the pre-update model on basis of the operating data in the operating data storage 213. Similarly, the failure symptom detector 211 calculates the value representing the occurrence possibility of the failure using the operating data in the operating data storage 213 and the post-update model. In the case of the logistic regression model, as the value representing the occurrence possibility of the failure, the failure probability “P”, the failure symptom rank, or the like is calculated. In the case of the support vector machine, the linear discriminant analysis model or the like, for example, a determination result of the “presence of the failure symptom” or the “absence of the failure symptom” is calculated. Hereafter, the value calculated using the pre-update model is called a “pre-update detection result”, and the value calculated using the post-update model is called a “post-update detection result”. In particular, in the case where the detection results are the failure probabilities, they are sometimes called a pre-update failure probability and a post-update failure probability. In the case where the detection results are the ranks, they are sometimes called a pre-update rank and a post-update rank. In the case where the detection results are the determination results, they are sometimes called a pre-update determination result and a post-update determination result.

The failure symptom detector 211 transmits the pre-update detection result and the post-update detection result to the model parameter calculation device. In transmitting, a “product ID” (serial number and the like) of the HDD is also transmitted alongside. This is because the model parameter calculation device side specifies the machine type of the HDD from the “product ID”. When information designating the HDD machine type is present, a configuration in which the machine type information is transmitted to the model parameter calculation device is possible. Moreover, in addition to the “product ID” of the HDD, a “terminal ID” (serial number of the terminal; E-mail address of the user; and the like) of the terminal may be transmitted.

The inspection processor 212 receives an inspection request from the model parameter calculation device. The inspection processor 212 performs inspection of the HDD by performing an inspection program with the CPU in accordance with the inspection request. While a method of the inspection is not limited to a specific one, examples thereof include, a read test over all of the sectors (whole surface read test). In the inspection, at least one item which is beforehand designated is inspected. Examples thereof include a read error rate, an unrecoverable sectors number and the like. Comprehensive judgment of the inspection of the items brings the inspection result. For example, when the unrecoverable sectors number is equal to or greater than the threshold, (irrespective of the inspection result of the other items), abnormality is determined. Moreover, when the read error rate is equal to or smaller than the threshold, (irrespective of the inspection result of the other items), the abnormality is determined. The inspection result may bring one of two kinds which are the presence of the abnormality and the absence of the abnormality (normality), or may bring one of three stages or more which are the presence of the abnormality, to be cautioned, the absence of the abnormality, and the like. Any other method other than those mentioned here may be used for the determination. The inspection processor 212 returns the inspection result to the model parameter device.

The model parameter calculation device 101 includes a comparator 121, a requester 122, a parameter determiner 123, a machine type ID storage 124, a training data storage 125 and an acquirer 126.

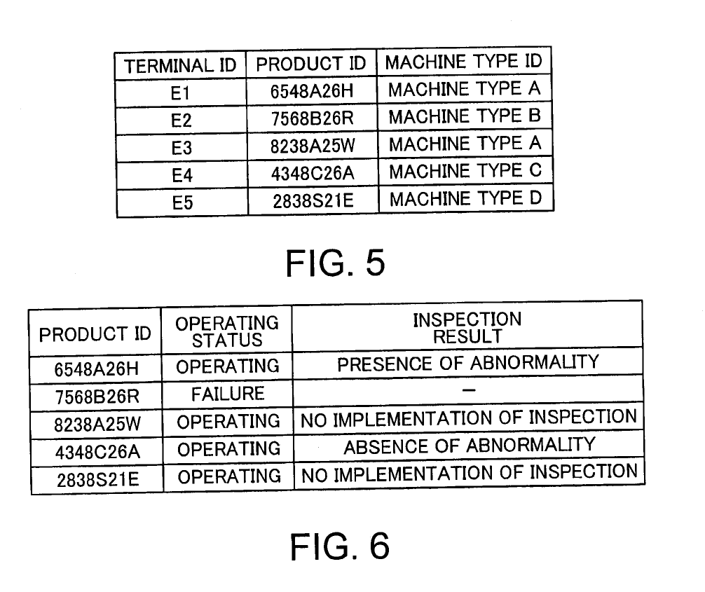

The machine type ID storage 124 stores a machine type ID table in which the “terminal ID” and the “product ID” and the “machine type ID” of the HDD are associated with one another. An example of the machine type ID table is illustrated in FIG. 5. The “terminal ID” of each terminal and the “product ID” of the HDD are beforehand registered in the machine type ID table. The “terminal ID” includes, by way of example, the serial number of the terminal, an IP address, the E-mail address of the user, and the like. Referring to the machine type ID table can specify the machine type of the HDD from the “product ID” of the HDD. The machine type is discriminated on basis of the model number, the product name or the like.

The training data storage 125 stores the training data for each “product ID”. The training data includes the “product ID” and the operating status and the inspection result of the HDD. FIG. 6 illustrates an example of a training data table stored in the training data storage 125. The operating status indicates the HDD being operating or under failure. The value of the “operating status” allows the operating status of the HDD to be recognized. The inspection result represents a result of read inspection of the HDD in the terminal. The “presence of abnormality” means that the state of the HDD does not satisfy a predetermined standard. The “absence of abnormality” means that it satisfies the predetermined standard. Notably, when the inspection result of the terminal is to be “cautioned” or the like, any of a configuration in which it is included in the “presence of abnormality” and a configuration in which it is included in the “absence of abnormality” is possible. Here, “no implementation of inspection” indicates that the inspection result of the HDD has not yet been acquired even once (otherwise, that the inspection of the HDD has not yet been performed even once). Sign “−” indicates a case where the HDD has already under failure in the occasion of data registration into the training data storage 125. In this case, the relevant HDD does not necessarily have to undergo the inspection.

When the operating HDD on the terminal side is under failure, failure notification is sent from the terminal to the model parameter calculation device. The model parameter calculation device, updates the operating status of the relevant HDD as the “failure” in the training data table. Otherwise, when the HDD is determined to be under failure after it is carried in a repair center or the like, a device such as a PC in the repair center may send the failure notification. When the failure is solved in the repair center, the repair center or the terminal in which the HDD after repair is implemented may send notification indicating that the HDD is operating. In this case, the operating status may be updated as the “operating” from the “failure”.

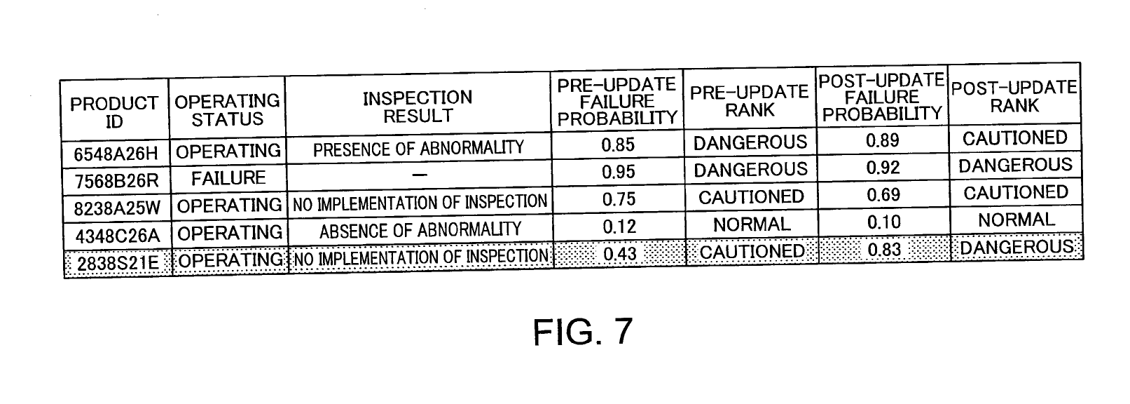

The comparator 121 is connected to the training data storage 125, the machine type ID storage 124 and the requester 122. The comparator 121 manages a detection result table having the pre-update detection result and the post-update detection result added to the training data table. The detection result table is stored in a storage which can be accessed from the comparator 121 or in an internal buffer. An example of the detection result table is illustrated in FIG. 7. In this example, as the pre-update detection result, the pre-update failure probability and the pre-update rank are stored. As the post-update detection result, the post-update failure probability and the post-update rank are stored. Only one of the failure probability and the rank may be stored. Otherwise, the pre-update determination result and the post-update determination result may be stored. When the training data table in FIG. 6 is updated, the relevant portions in the detection result table are also configured to be updated.

The comparator 121 adds the pre-update detection result and the post-update detection result received from the terminal to the detection result table. They may be overwritten to previous values when the previous values are present. Moreover, when the pre-update detection result and the post-update detection result are received from the terminal, the comparator 121 compares these results with each other. Thereby, it determines whether or not the HDD inspection is requested to the relevant terminal. When it is determined that the HDD inspection is requested, the comparator 121 selects this terminal as the sample terminal.

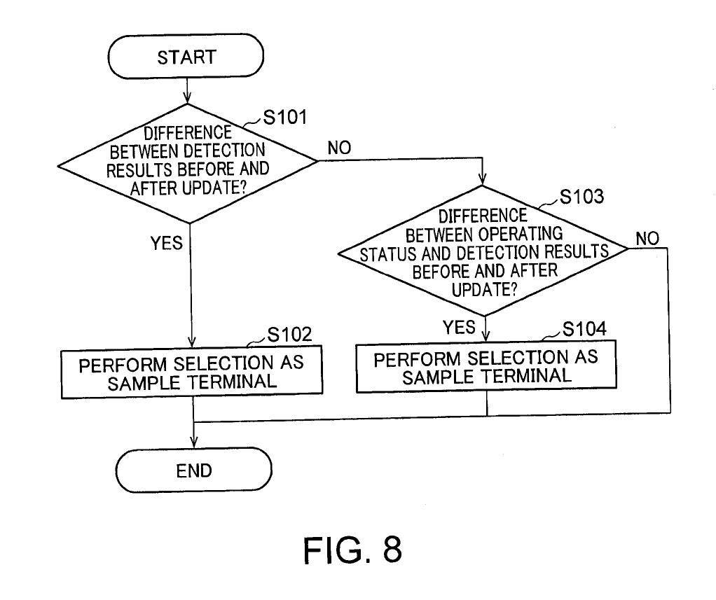

An example of a selection flow of the sample terminal is illustrated in FIG. 8. When there is a difference between the pre-update detection result and the post-update detection result, the relevant terminal is selected as the sample terminal (YES in S101; S102). For example, when the absolute value of the difference between the pre-update failure probability and the post-update failure probability is large, the relevant terminal is selected as the sample terminal. Otherwise, when the pre-update rank is different from the post-update rank, the relevant terminal is selected. Otherwise, when there is a difference in presence or absence of the failure symptom between the pre-update determination results or the post-update determination results, the relevant terminal is selected.

When there is a difference between the post-update detection result and the operating status of the training data although there is no difference between the pre-update detection result and the post-update detection result, the relevant terminal is selected as the sample terminal (YES in S103; S104). For example, consider a case where there is a difference between the operating status of the training data and the post-update rank. The rank has three of “dangerous”, “cautioned” and “normal”. It is supposed that the “failure” of the operating status corresponds to “dangerous” and “cautioned” and that the “operating” of the operating status corresponds to “normal”. In this case, when the operating status is the “operating” and the post-update rank is “dangerous” or “cautioned”, the difference is determined (refer to the lowermost row in FIG. 7). Otherwise, the terminal for which a difference between the operating status and the post-update failure probability is large may be selected as the sample terminal (refer to the lowermost row in the FIG. 7). For example, “0” is allocated to the “operating” and “1” is allocated to the “failure”, when the absolute value of a difference between the allocated value and the post-update failure probability is equal to or greater than a certain value, that terminal is selected. Otherwise, when there is a difference between the operating status and the post-update determination result, the relevant terminal may be selected. For example, when the operating status is the “operating” and the post-update determination result is the “presence of the failure symptom”, the relevant terminal is selected as the sample terminal.

Herein, whether the HDD of the relevant terminal corresponds to the machine type as a model update target may be investigated to be selected as the sample terminal only in the case of the correspondence. Whether the machine type of the HDD of the terminal corresponds to the machine type as the model update target can be determined by specifying the machine type of the HDD on basis of the “product ID” of the relevant HDD and the correspondence table in the machine type ID storage 124, and on basis of whether the specified machine type coincides with the machine type as the model update target.

Moreover, to the detection result table in FIG. 7, a date and time field may be added to add date and time when the comparison is performed. No selection as the sample terminal may be performed in the case within a certain period since the date and time when the previous comparison is performed. This is because the HDD inspection reperformed in a short period since the previous HDD inspection results in a low probability of change in inspection result.

The requester 122 sends the inspection request of the HDD to the sample terminal selected by the comparator 121. Otherwise, a configuration in which a detection frequency increase request is sent in place of transmission of the inspection request is possible. The inspection request is a request for performing the inspection of the HDD by performing the inspection program with the CPU of the terminal. The detection frequency increase request is a request for increasing a performance frequency of the failure symptom detection by the failure symptom detector 211.

The failure symptom detector 211 of the terminal which has received the inspection request performs the inspection of the HDD by performing the inspection program with the inspection processor 212. The method of the inspection is mentioned above. The terminal transmits the inspection result to the model parameter calculation device. Notably, the inspection result transmitted from the terminal is enough to be one spontaneously made before reception of the inspection request. The inspection result is acquired by the acquirer 126. The acquirer 126 is connected to the training data storage 125. It adds the acquired inspection result to the inspection result field of an entry which has the relevant “product ID” in the training data storage 125. By doing so, new training data is acquired (the training data is updated).

The terminal which has received the detection frequency increase request increases the frequency of the failure symptom detection. For example, a measurement frequency of the operating data is increased and the failure symptom detection is performed for each measurement of the operating data. By doing so, the model parameter calculation device can raise the acquisition frequency (update frequency) of the training data and enhance the model accuracy. Moreover, the terminal side can increase an opportunity of the failure symptom detection using the post-update model. A period may be configured to the detection frequency increase request and the frequency of the failure symptom detection may be increase only during the period. During the period, the detection frequency increase request may be configured not to cause its duplicated transmission. Otherwise, a configuration in which the terminal is requested with detection frequency increase to increase the frequency gradually is also possible.

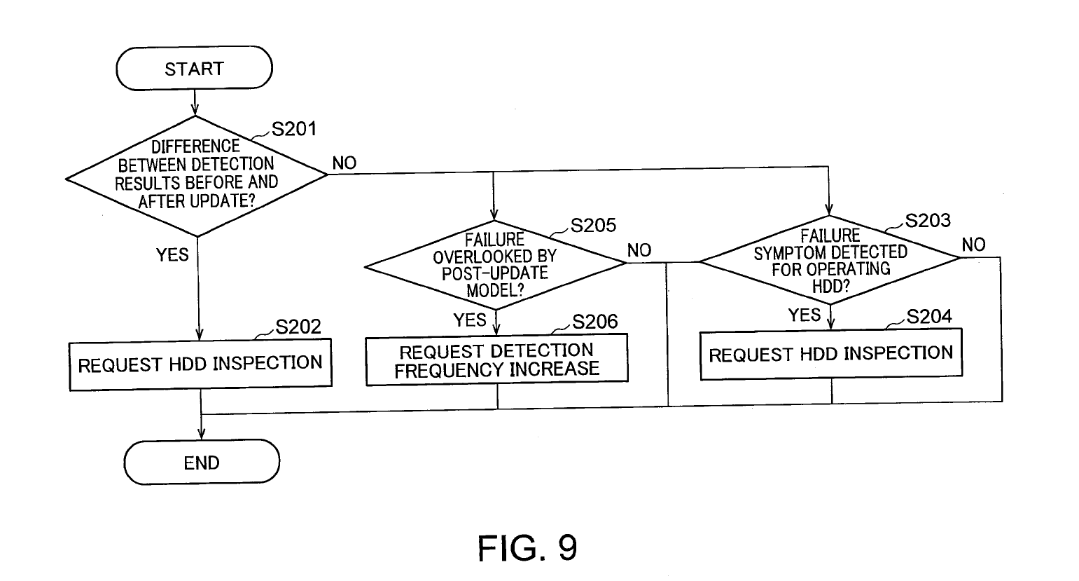

Herein, the requester 122 can determine, using an arbitrary method, which of the inspection request and the detection frequency increase request is transmitted. An example of a request determination flow in the requester 122 is illustrated in FIG. 9. The requester 122 determines, for example, whether there is a difference between the pre-update detection result and the post-update detection result. It transmits the inspection request in the case of the presence of the difference (YES in S201; S202). Specifically, this status corresponds to any of: the case where the absolute value of the difference between the pre-update failure probability and the post-update failure probability is large; the case where the pre-update rank is different from the post-update rank; and the case where there is the difference in presence or absence of the failure symptom between the pre-update determination results or the post-update determination results.

Also when the failure symptom is detected for the Operating HDD although there is no difference between the pre-update detection result and the post-update detection result, the inspection request is transmitted (NO in S201; YES in S203; S204). Specifically, this status corresponds to the case where the operating status is the “operating” and the post-update (or pre-update) rank is “dangerous”. Otherwise, this status also corresponds to any of: the case where the operating status is the “operating” and the absolute value of a difference between the post-update (or pre-update) failure probability and the value indicating the “operating” is equal to or greater than a certain value; and the case where the operating status is the “operating” and the post-update (or pre-update) determination result is the “presence of the failure symptom”.

On the other hand, when there is a probability that the post-update model overlooks the failure symptom although there is no difference between the pre-update detection result and the post-update detection result, the detection frequency increase request is transmitted (NO in S201; YES in S205; S206). The probability that the failure is overlooked corresponds to the case where the result of the inspection for the HDD for which the operating status is the “failure” (failure HDD) using the post-update model is the absence of the failure symptom (that is, low occurrence possibility) and the operating data history of the sample terminal is similar to the operating data history of the relevant failure HDD. The absence of the failure symptom (low occurrence possibility) corresponds, for example, to any of: the case where the rank is “normal”; the case where the failure probability is equal to or smaller than the threshold; and similar cases.

Whether the operating data histories are similar to each other can be determined, for example, using a distance between pieces of the operating data. The features “x₁” . . . “xₖ” allocated to the variables are compared with one another in a vector space. In that case, a distance between two points (for example, a Euclidean distance or Manhattan distance) is calculated. It is determined that both operating data histories are similar to each other when the distance is equal to or smaller than the threshold.

The failure HDD as a determination target may be selected, as an arbitrary one, out of the failure HDDs for which the post-update model inspection result is the “absence of the failure symptom”. Otherwise, plural failure HDDs may be selected to determine for which failure HDD among them the operating data histories are similar to each other. When the operating data histories are similar to each other, it is considered that there is a probability that the failure symptom is overlooked for the relevant terminal. Hence, the detection frequency increase request is transmitted to the relevant terminal.

Other methods for determining the similarity between the operating data histories can include, for example, a method in which a state machine which performs the failure determination is generated from the operating data histories of the plural failure HDDs for which there is a probability that the failure symptom is overlooked. To the state machine, the operating data history of the sample terminal is applied. When the state machine determines the failure, it is determined that the operating data histories are similar to each other. Any arbitrary method other than the methods mentioned here may be used as long as it can determine the similarity between the operating data histories.

The parameter determiner 123 is connected to the training data storage 125 and the machine type ID storage 124. A storage which stores the operating data received from the terminals may be provided in the model parameter calculation device such that the parameter determiner 123 can access the relevant storage. Otherwise, the parameter determiner 123 may acquire the required operating data by sequential communication with the terminals to store it in an internal buffer or the accessible storage. The parameter determiner 123 generates the model using the operating data of the terminals and the training data in the training data storage 125. Specifically, in accordance with the model reference according to the beforehand designated model type, the model parameter is determined. Generation of the model (determination of the parameter) is performed for each machine type of the HDDs. Such processing of generating the model, or determining the parameter, is called model update processing or parameter update processing. Timing of the parameter update processing can be determined using an arbitrary method. For example, it may arise for each update of the training data for the relevant machine type in the training data storage 125, or for each update of a certain number of pieces of the training data, or may be timing designated by an administrator or similar timing.

The model type is beforehand designated. Information indicating the model type may be stored in the storage which can be accessed by the parameter determiner 123 or in the internal buffer beforehand. The parameter determiner 123 determines the parameter in accordance with the model reference corresponding to the relevant model type. A new model is defined from the determined parameter and the above-mentioned model type. When the model type is changed, information indicating the model type after the change is sufficient to be stored in the storage or the internal buffer.

When the model type is the logistic regression model, the parameter (coefficients “a₀” . . . “aₖ”; kinds of the variables “x₁” . . . “xₖ”) is determined such that a log-likelihood “L” (model reference) calculated using the following formula becomes largest. In order to solve this problem, a known technique such as the Newton method and the steepest descent method is sufficient to be used. Notably, instead of the log-likelihood “L” to be largest, the parameter may be determined such that the log-likelihood “L” is equal to or greater than a threshold or falls within a predetermined range.

[Formula 3]

L=Σₙ{cₙ ln Pₙ+(1−cₙ)ln(1−Pₙ)} formula (3)

Herein, “n” denotes an index of the terminal for which the training data is present. Moreover, “c” is a variable which is “1” when the operating status is the “failure” or the inspection result is the “abnormality” and which, otherwise, is “0”. “P” is the failure probability calculated using the formula (1). In the case of the logistic regression model, accordance with the model reference corresponding to the model type means that the log-likelihood is allowed to be largest, to be equal to or greater than the threshold or to fall within the predetermined range.

Determination in accordance with the formula (3) possibly changes the kinds of the variables included in the model. Namely, plural combinations of the variables may be generated to select the combination that affords the lowest log-likelihood out of the combinations. The kinds of the variables may be fixed of course. In this case, the result of the model update processing does not change the kinds of the variables but only updates the coefficients.

When the model type is the support vector machine, the parameter (coefficients “a₀” . . . “aₖ”; kinds of the variables “x₁” . . . “xₖ”) is determined such that a loss function “L” below becomes smallest. Notably, “λ” is a positive constant. Instead of the loss function “L” to be smallest, the parameter may be determined such that the loss function “L” is equal to or smaller than a threshold or falls within a predetermined range.

### [Formula 4]

$$L = \frac{1}{2} {\sum }_{j = 1}^{k} {a}_{j}^{2} + λ {\sum }_{n} {ξ}_{n} \\ s . t . {c}_{n} ( {a}_{0} + {a}_{1} {x}_{1} + {a}_{2} {x}_{2} + … + {a}_{k} {x}_{k} ) + {ξ}_{n} \geq 1 , \\ {ξ}_{n} \geq 0 \qquad formula ( 4 )$$

In the case of the support vector machine, accordance with the model reference corresponding to the model type means that the predetermined loss function including the coefficients “a₀” . . . “aₖ” and the variables “x₁” . . . “xₖ” is allowed to be smallest, to be equal to or smaller than the threshold or to fall within the predetermined range.

In the case where the model type is the linear discriminant analysis model, the parameter (coefficients “a₀” . . . “aₖ”; kinds of the variables “x₁” . . . “xₖ”) is determined such that the loss function “L” below becomes smallest. Instead of the loss function “L” to be smallest, the parameter may be determined such that the loss function “L” is allowed to be equal to or smaller than a threshold or to fall within a predetermined range.

### [Formula 5]

$$L = \frac{{a}^{T} {S}_{{B}^{a}}}{{a}^{T} {S}_{{W}^{a}}} \\ {μ}_{+} = \frac{1}{{N}_{+}} {\sum }_{m {c}_{n} = 1} {X}_{n} , {μ}_{-} = \frac{1}{{N}_{-}} {\sum }_{m {c}_{n} = 0} {X}_{n} \\ {S}_{B} = ( {μ}_{+} - {μ}_{-} ) {( {μ}_{+} - {μ}_{-} )}^{T} \\ {S}_{W} = {\sum }_{m {c}_{n} = 1} ( {X}_{n} - {μ}_{+} ) {( {X}_{n} - {μ}_{+} )}^{T} + {\sum }_{m {c}_{n} = 0} ( {X}_{n} - {μ}_{-} ) {( {X}_{n} - {μ}_{-} )}^{T} \qquad formula ( 5 )$$

where Xₙ which is a vector having “x₁” . . . “xₖ” as its elements completes, and N₊ is the number of terminals for cₙ=1 and N_ is the number of terminals for cₙ=0.

In the case of the linear discriminant analysis model, accordance with the model reference corresponding to the model type means that the predetermined loss function including the coefficients “a₀” . . . “aₖ” and the variables “x₁” . . . “xₖ” is allowed to be smallest, to be equal to or smaller than the threshold or to fall within the predetermined range.

The parameter determiner 123 transmits the calculated model (determined parameter and model type) to the terminal having the HDD of the relevant machine type for each HDD machine type. The terminal which receives the relevant model reads out the model (model parameter; model type) in the post-update model storage 215 with the updater 216, overwrites it to the pre-update model storage 214, and overwrites the currently received model (determined parameter and model type) to the post-update model storage 215.

Notably, when the model type to be used is beforehand fixed, the parameter determiner 123 may omit transmission of the information indicating the model type. In this case, the terminal does not have to store the model type in the pre-update model storage 214 or the post-update model storage 215. The failure symptom detector 211 is enough to be beforehand given the information indicating the model type or to be caused to read out the information of the model type from another accessible storage.

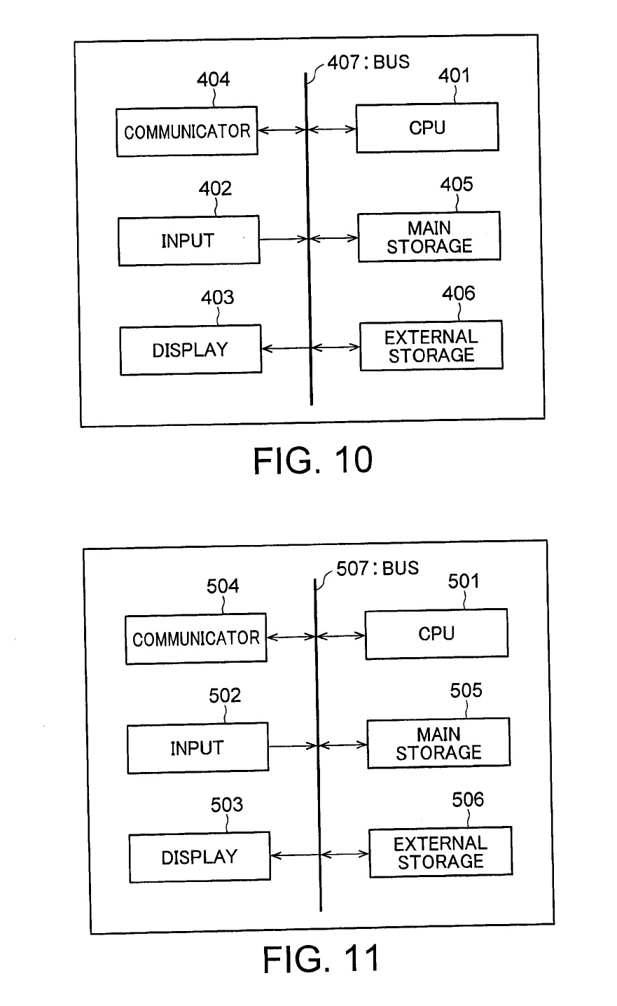

FIG. 10 illustrates an exemplary hardware configuration of the terminal. The terminal includes a CPU 401, an input 402, a display 403, a communicator 404, a main storage 405 and an external storage 406 which are connected via a bus 407, so that these can communicate with one another.

The input 402 includes input devices such as a keyboard and a mouse. The display 403 includes a display such as a liquid crystal display (LCD) and a cathode ray tube (CRT). The communicator 404 has wireless or wired communicating means and performs communication in a predetermined communication scheme.

The external storage 406 includes a storage medium such, for example, as an HDD, an SSD, a memory device, a CD-R, a CD-RW, a DVD-RAM and a DVD-R. The external storage 406 stores a program for causing the CPU 401 to execute processing of the failure symptom detector 211, the inspection processor 212 and the updater 216. Moreover, the external storage 406 also includes the operating data storage 213, the pre-update model storage 214 and the post-update model storage 215. While only one external storage 406 is illustrated here, plural ones may be present. In this case, the failure symptom detection may be performed for one external storage as a target or may be performed for each of the plural external storages.

The main storage 405 expands a control program stored in the external storage 406 under the control with the CPU 401 and stores data required in executing the program, data generated in executing the program, and similar data. The main storage 405 includes an arbitrary memory such, for example, as a non-volatile memory.

FIG. 11 illustrates an exemplary hardware configuration of the model parameter calculation device. The model parameter calculation device includes a CPU 501, an input 502, a display 503, a communicator 504, a main storage 505 and an external storage 506 which are connected via a bus 507, so that these can communicate with one another.

The input 502 includes input devices such as a keyboard and a mouse. The display 503 includes a display such as a liquid crystal display (LCD) and a cathode ray tube (CRT). The communicator 504 has a wireless or wired communicator and performs communication in a predetermined communication scheme.

The external storage 506 includes a storage medium such, for example, as an HDD, an SSD, a memory device, a CD-R, a CD-RW, a DVD-RAM and a DVD-R. The external storage 506 stores a program for causing the CPU 501 to execute processing of the comparator 121, the requester 122 and the parameter determiner 123. Moreover, the external storage 506 also includes the machine type ID storage 124 and the training data storage 125. The storage to store the above-mentioned model type may be included here. Moreover, the storage to store the operating data received from the terminals may be included here. While only one external storage 506 is illustrated here, plural ones may be present.

The main storage 505 expands a control program stored in the external storage 506 under the control with the CPU 501 and stores data required in executing the program, data generated in executing the program, and similar data. The main storage 505 includes an arbitrary memory such, for example, as a non-volatile memory.

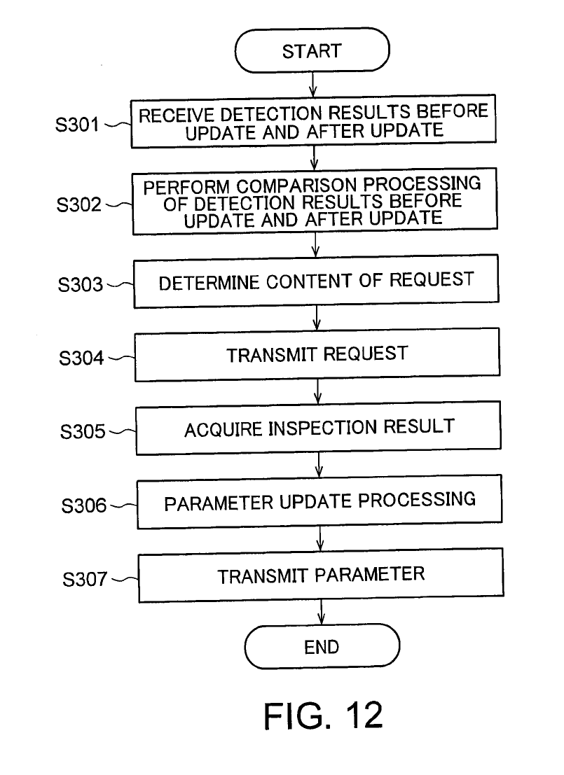

FIG. 12 illustrates an operation flowchart of the model parameter calculation device according to the embodiment.

The comparator 121 receives the pre-update detection result and the post-update detection result from the terminal (S301). The comparator 121 may add these detection results to the detection result table illustrated in FIG. 7.

The comparator 121 compares the detection results with each other and determines whether the relevant terminal is selected as the sample terminal in accordance with the above-mentioned flow illustrated in FIG. 8 (S302). When the terminal is not selected as the sample terminal, the process is returned to step S301.

In the case of selection as the sample terminal, the comparator 121 determines whether the inspection request or the detection frequency increase request is transmitted to the relevant sample terminal (S303). This determination is sufficient to be performed in accordance with the above-mentioned flow illustrated in FIG. 9.

According to the determination in the comparator 121, the requester transmits the inspection request or the detection frequency increase request to the terminal (S304).

The acquirer 126 acquires the inspection result of the HDD performed in the inspection processor 212 of the terminal, and adds the acquired inspection result to the inspection result field of the entry having the relevant “product ID” in the training data storage 125 (S305).

The parameter determiner 123 determines the parameter using the operating data and the training data in accordance with the model reference corresponding to the predefined model type (S306). The determination of the parameter is performed for each machine type.

The parameter determiner 123 transmits the model including the parameter after the update and the model type to the terminal having the HDD of the relevant machine type (S307).

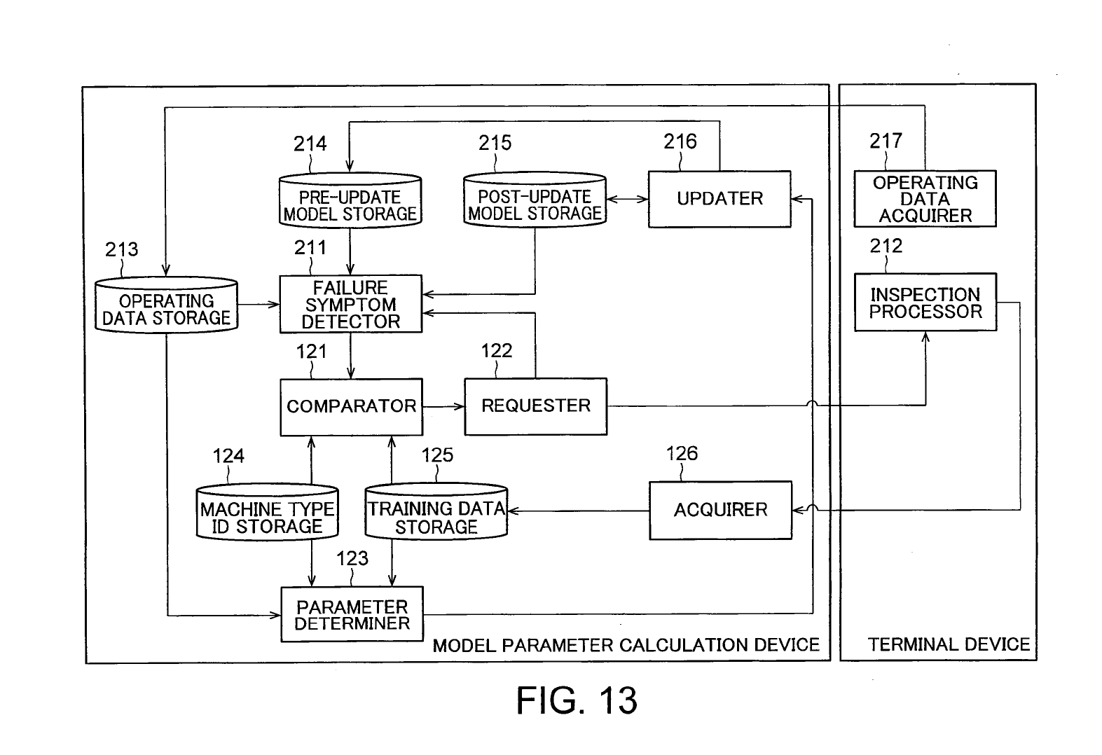

FIG. 13 illustrates a block diagram of a variation of the model parameter calculation device and the terminal device according to the embodiment. The elements with the identical names in FIG. 2 are given the same signs and duplicated description is omitted.

The failure symptom detector 211, the pre-update model storage 214, the post-update model storage 215, the updater 216 and the operating data storage 213 in FIG. 2 are moved from the terminal to the model parameter calculation device. In other words, the model parameter calculation device performs the collection of the operating data from the terminal, and the failure symptom detection using each of the pre-update model and the post-update model. Moreover, the model parameter calculation device also performs the update processing in the pre-update model storage 214 and the post-update model storage 216. Moreover, the model parameter calculation device performs the failure symptom detection processing using the post-update model for the relevant machine type for each terminal. When the failure symptom is detected, a message for reporting the failure symptom is transmitted to the terminal. In this way, in the device that calculates the model parameter, a mechanism for performing the failure symptom detection of the terminal according to the embodiment can be implemented.

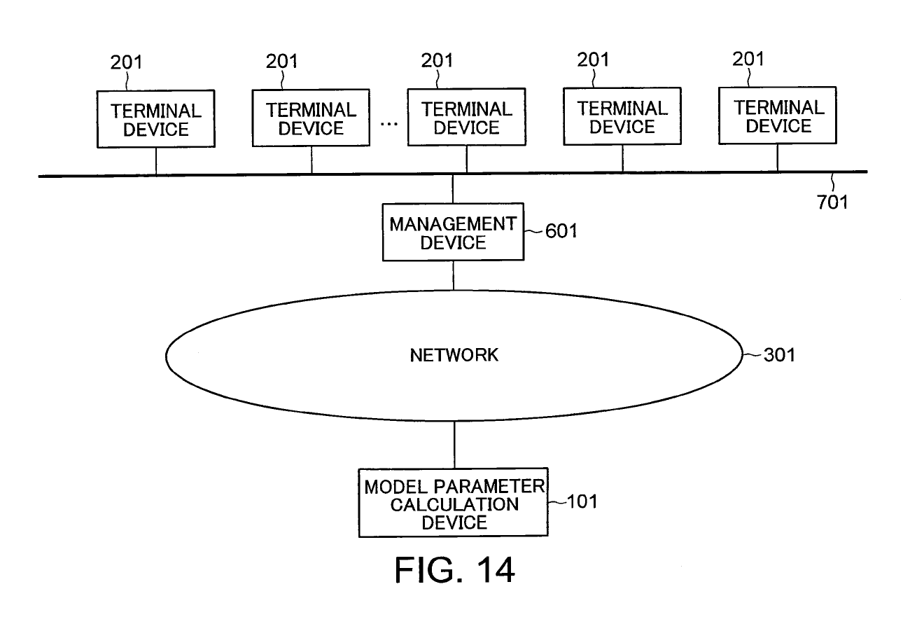

FIG. 14 is a diagram illustrating a variation of the network configuration according to the embodiment. While the model parameter calculation device 101 is directly connected to the terminals 201 via the network 301 in FIG. 1, the calculation device 101 may be connected to a management device 601 to manage the terminals 201. The management device 601 is connected to the terminals 201 via a network 701. The network 701 may be same as or different from the network 301.

Here, the processor that is moved from the terminal to the model parameter calculation device in FIG. 13 is moved to the management device 601. Namely, the management device 601 includes the pre-update model storage 214, the post-update model storage 215, the updater 216 and the operating data storage 213 and performs the collection of the operating data from the terminal and the failure symptom detection using each of the pre-update model and the post-update model. The model parameter calculation device 101 performs the inspection request to the management device 601. The management device 601 transfers the relevant inspection request to the terminals and acquires the inspection results. The management device 601 feeds back the inspection results to the model parameter calculation device 101. Moreover, the model parameter calculation device 101 sends the updated parameter and the like to the management device 601. The updater 216 in the management device 601 performs the update processing of the pre-update model storage 214 and the post-update model storage 216. When the failure symptom is detected using the post-update model corresponding to the HDD machine type of each terminal, the management device 601 transmits a message for reporting the failure symptom to the terminal. In this way, the embodiment can be applied to the case where the management device performs the failure symptom detection of the terminal.

As above, according to the embodiment, the pre-update detection result and the post-update detection result are compared with each other, and the inspection result of the HDD is acquired only from the terminal for which the comparison result has a difference. Thereby, efficient acquisition of the training data is possible. When the detection result has a difference, it can be determined that the current model used for the failure symptom detection (post-update model) has not yet reached sufficient convergence (is not high in accuracy). Only in such a case, the inspection of the HDD is performed. Thereby, the training data that contributes improvement of the model accuracy can be efficiently collected. To perform the HDD inspection for all of the terminals (to execute the inspection program) is a heavy load on the system as a whole, which possibly leads to high costs. Moreover, accumulation of the data of the HDDs that actually suffer the failure takes time since the number of events of the failure is small for a new machine type. Therefore, according to the embodiment, the terminals that the HDD inspection is performed for are carefully selected using the above-mentioned technique. On basis of the inspection results from those terminals, the training data is acquired. Hence, the model can be updated quickly and low in costs. Accordingly, the effect that the overlooking and the erroneous warning are made less for the HDD machine types in a new generation can be realized.

### Second Embodiment

In the embodiment, a large variation of the HDDs that the inspection results are acquired from is to be attained. As a block diagram of the embodiment, the block diagram in FIG. 2 is used because of similarity to the first embodiment.

While the sample terminals are selected in accordance with the flow of FIG. 8 in the first embodiment, only the terminals that further satisfy the following condition are selected as the sample terminals in the embodiment.

When the terminal satisfies the condition in S101 or S103 of FIG. 8, the comparator 121 compares the values of the variables “x₁” . . . “xₖ” (features) used for the post-update model (or the pre-update model) between the relevant terminal and another terminal that the HDD of the same machine type is implemented in, in the vector space. Namely, a distance between a point represented by a set of the variables of the relevant terminal and a point represented by a set of the variables of the other terminal (for example, the Euclidean distance or the Manhattan distance) is calculated. When the calculated distance is equal to or greater than a threshold, the relevant terminal is selected as the sample terminal, and when it is less than the threshold, the selection is not performed. By doing so, a deviation of the data used for the parameter update can be suppressed and the effect that efficiency of the model update is improved can be obtained.

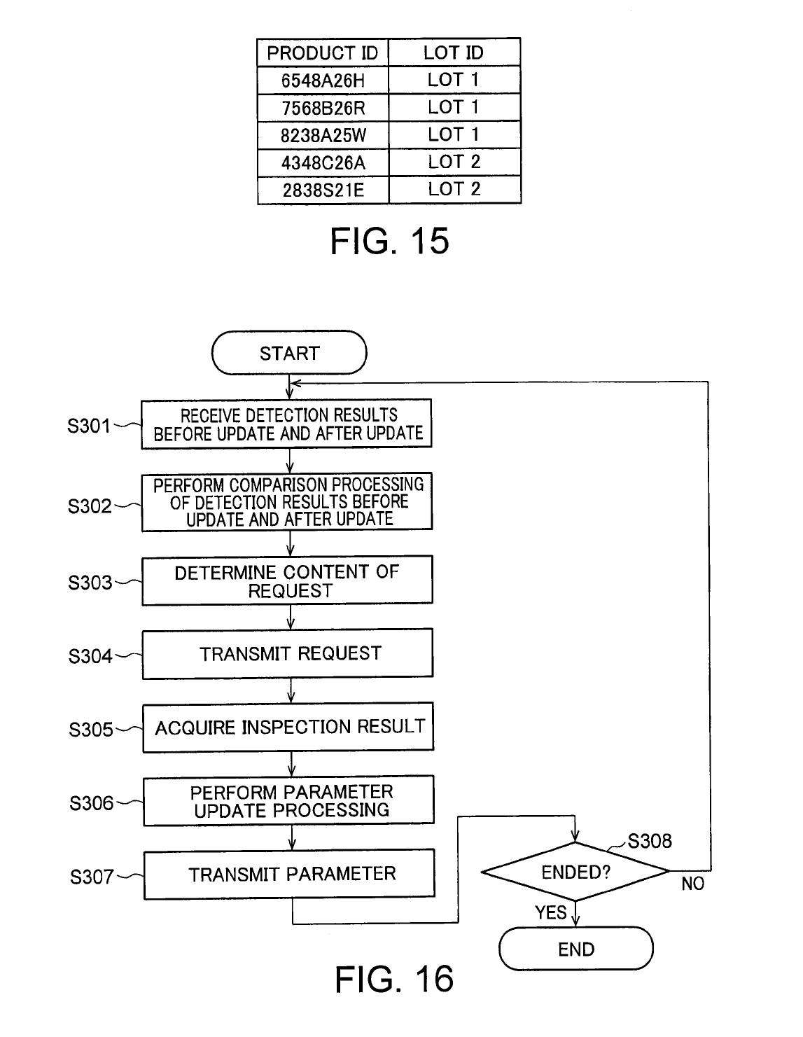

As another method, for example, the sample terminals can also be selected such that their production lots are different from one another. A lot ID table in which the “product ID” of the HDD is associated with a “lot ID” is illustrate in FIG. 15. This table may be stored along with the machine type ID table in the machine type ID storage 124, or a field of the “lot ID” may be added to the machine type ID table. When the terminal satisfies the condition in. S101 or S103 of FIG. 8, the comparator 121 investigates whether the terminal that has the same “lot ID” as that of the relevant terminal has already been selected as the sample terminal. In the case where the relevant terminal has not been selected, the relevant terminal is selected as the sample terminal. In the case where the selection has been done, the relevant terminal is not selected as the sample terminal. Otherwise, plural sample terminals may be configured to be selected for each lot, and the terminals may be selected such that the difference in number of the sample terminals is equal to or smaller than a threshold between the lots, that is, such that a variation between the lots is suppressed. By doing so, a deviation of the data used for the parameter update can be suppressed and the model update can be efficiently performed.

### Third Embodiment

In the embodiment, a determination processing of ending of the update is added to the parameter update processing (model update processing) in the first embodiment. As a block diagram of the embodiment, the block diagram in FIG. 2 is used because of similarity to the first embodiment.

FIG. 16 illustrates an operation flow of a model parameter calculation device according to the embodiment. A step S308 regarding the ending determination is added after step S307 in FIG. 12 used for the first embodiment.

In step S308, the parameter determiner 123 determines whether the parameter of the model for the relevant machine type has reached the convergence, on basis of whether or not a convergence condition is satisfied. For example, when the kinds of the variables are same continuously over certain times of repetition in updating the parameter, it is determined that the convergence condition is satisfied. Otherwise, in the case where the kinds of the variables used are fixed, when a difference between the values of the coefficient to each variable before and after the update is equal to or smaller than a threshold for all of the variables, it is determined that the convergence condition is satisfied. In the case of being equal to or smaller than the threshold not for all of the variables but for one or plural variables, it may be determined that the convergence condition is satisfied. Otherwise, when a certain number or more of the sample terminals are collected, it may be determined that the convergence condition is satisfied.

As above, according to the embodiment, after the convergence condition of the parameter is satisfied, the update of the parameter (update of the model) is not performed. By doing so, load on the model parameter calculation device can be reduced. Moreover, the model used for monitoring the operating HDDs can be fixed to be run afterward.

### Fourth Embodiment

A set of the sample terminals selected according to the first embodiment does not include randomly selected specimens. Due to this, a distribution of the set of the sample terminals has a bias unlikely to a distribution for the entirety of the operating HDDs. The embodiment is characterized in that this bias is corrected such that the same effect as in the selection of the sample terminals according to the distribution for the entirety of the operating HDDs can be obtained. As a block diagram of the embodiment, the block diagram in FIG. 2 is used because of similarity to the first embodiment.

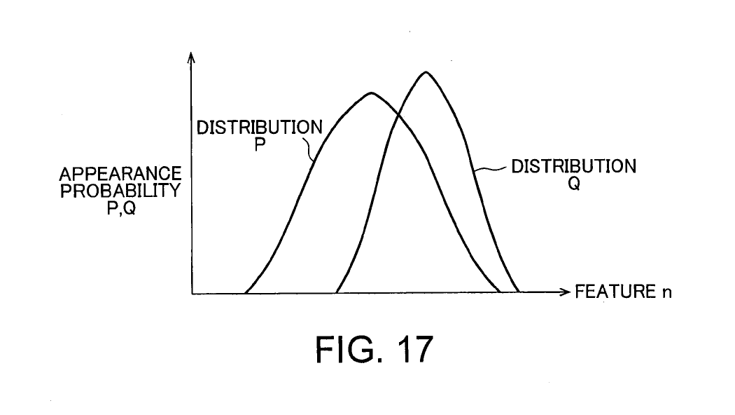

As illustrated in FIG. 17, a probability distribution of features “n” for all of the terminals in which the operating HDDs are implemented is set as “P”. A probability distribution of the features for the set of the sample terminals is set as “Q”. Herein, a weighted value “wₙ” of a sample terminal “n” is calculated using the following formula. Sign “xₙ” is a value of the feature “n” for the sample terminal “n”.

### [Formula 6]

$${w}_{n} = \frac{P ( {x}_{n} )}{Q ( {x}_{n} )} \qquad formula ( 6 )$$

The model reference is corrected using these weighted values. For example, in the case where the model type is the logistic regression model and the parameter is updated such that the log-likelihood becomes largest, the formula (3) in the first embodiment is corrected to be an formula (7) below. In other words, components for each sample terminal in the log-likelihood are multiplied by the weighted value.

### [Formula 7]

$$L = {\sum }_{n} {w}_{n} \{ {c}_{n} ln {P}_{n} + ( 1 - {c}_{n} ) ln ( 1 - {P}_{n} ) \} \qquad formula ( 7 )$$

Updating the parameter using the formula (7) corrects the selection bias and can improve the model accuracy.

Herein, calculation of the distribution “P” is sufficient to be performed for all of the terminals in which the HDDs with the operating status being the “operating” in the training data table of FIG. 6 are implemented as targets. Moreover, calculation of the distribution “Q” is sufficient to be performed for ones with the inspection result expect for being “no implementation of inspection” out of all of the terminals to be the set of the sample terminals as targets.

Moreover, timing of calculation of the distributions “P” and “Q” may arise at a certain period of interval, every time a certain number of the sample terminals are selected by the comparator 121, or immediately before the parameter update processing. It may be timing other than ones mentioned herein.

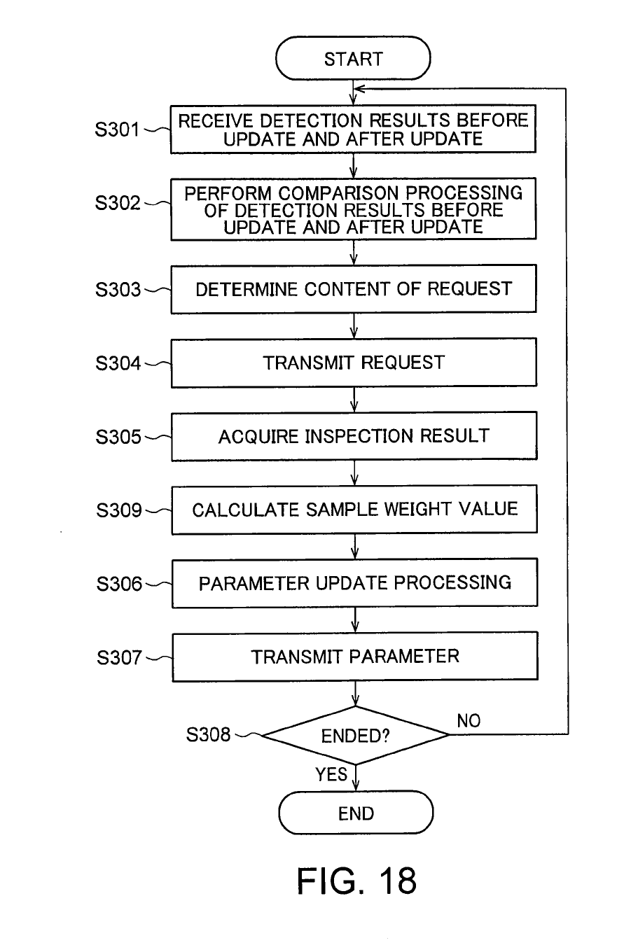

FIG. 16 is a flowchart of operation of a model parameter calculation device according to the embodiment. The step S309 is added between step S305 and step S306 in the flowchart of FIG. 18 used for the third embodiment.

In step S309, the parameter determiner 123 calculates the weighted values of the terminals before the parameter update (S306). Calculation of the weighted value is performed in accordance with the formula (6). The parameter determiner 123 previously calculates the distributions “P” and “Q” and calculates the weighted values on basis of “P”, “Q” and the features of the terminals.

As above, according to the embodiment, the weighted values are calculated for each terminal and the model reference is corrected using the weighted values to update the parameter. By doing so, the selection bias is corrected and the model accuracy can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A model parameter calculation device including a processor, comprising:
a comparator to compare a first evaluation value with a second evaluation value wherein
the first evaluation value is calculated on basis of a first model and operating data of a terminal device, the first model represents relationship between at least one first parameter including at least one first variable and a first output variable regarding an occurrence possibility of a failure in the terminal device, the first variable being allocated with at least one feature based on operating data of the terminal device, and
the second evaluation value is calculated on basis of a second model and the operating data, the second model represents relationship between at least one second parameter including at least one second variable and a second output variable regarding the occurrence possibility of the failure in the terminal device, the second parameter being allocated with at least one feature based on the operating data;
a requester to transmit an inspection request to inspect the terminal device to the terminal device or to a management device of the terminal device in accordance with a comparative relation between the first evaluation value and the second evaluation value; and
a parameter determiner to determine at least one third parameter included in a third model in accordance with a model reference of a predefined model type, on basis of an inspection result indicating an operating status of the terminal device and the operating data of the terminal device, wherein the third model represents relationship between the third parameter and a third output variable regarding the occurrence possibility of the failure in the terminal device, the third parameter includes at least one third variable being allocated with at least one feature based on the operating data.

2. The calculation device according to claim 1, wherein
each of the first model and the second model has the predefined model type, and
the first parameter includes at least one first coefficient for the first variable, the second parameter includes at least one second coefficient for the second variable, and the third parameter includes at least one third coefficient for the third variable.

3. The calculation device according to claim 1, wherein
the comparator compares the second evaluation value with a third evaluation value calculated from the third model on basis of the operating data of the terminal device, and
the requester transmits the inspection request to the terminal device or the management device in accordance with a comparative relation between the second evaluation value and the third evaluation value.

4. The calculation device according to claim 1, wherein
the requester transmits the inspection request when a difference between the first evaluation value and the second evaluation value is not less than a threshold.

5. The calculation device according to claim 1, wherein
the requester transmits the inspection request when a rank determined in accordance with the first evaluation value is different from a rank determined in accordance with the second evaluation value.

6. The calculation device according to claim 1, wherein
the comparator selects a terminal device for transmitting the inspection request from among a plurality of the terminal devices by comparing differences of features allocated to the second variable among the terminal devices.

7. The calculation device according to claim 1, wherein
the comparator preliminarily recognizes an operating status of the terminal device, and determines whether to transmit the inspection request to the terminal device by comparing the recognized operating status of the terminal device with the second evaluation value.

8. The calculation device according to claim 1, wherein
the requester acquires the second evaluation value on basis of operating data on a failed terminal device, and when the acquired second evaluation value indicates a low occurrence possibility of failure, the requester performs control such that an acquisition frequency of the first and second evaluation values for the terminal device is increased in accordance with a difference of features allocated to the second variable between the terminal device and the failure terminal device.

9. The calculation device according to claim 1, wherein
the calculation device calculates a first probability distribution that is an occurrence probability distribution of the features allocated to the second variable on a plurality of terminal devices,
calculates a second probability distribution that is an occurrence probability distribution of the features of the terminals device to which the inspection request has been transmitted out of the plurality of terminal devices, and
calculates occurrence probabilities of the features from the first and second probability distributions for each terminal device to which the inspection request has been transmitted, calculates a weight according to a relation between the occurrence probabilities, and update the model reference using the weight.

10. The calculation device according to claim 1, wherein the predefined model type is a logistic regression model, a support vector machine or a linear discriminant analysis model.

11. The calculation device according to claim 1, wherein
the parameter determiner transmits the determined third parameter to the terminal device or the management device.

12. The calculation device according to claim 1, wherein
the comparator acquires the first evaluation value and the second evaluation value from the terminal device or the management device via a network.

13. The calculation device according to claim 1, wherein
the comparator calculates the first evaluation value on basis of the operating data of the terminal device and the first model, and calculates the second evaluation value on basis of the operating data of the terminal device and the second model.

14. The calculation device according to claim 1, wherein
the terminal device includes a storage device, and the failure in the terminal device means a failure in the storage device.

15. The calculation device according to claim 14, wherein
the comparator selects the terminal device to transmit the inspection request so as to suppress a variation in number of terminal devices to which the inspection request is transmitted, among lots of storage devices mount on the terminal devices.

16. The calculation device according to claim 14, wherein
the first model is a model generated on basis of operating data on terminal devices which comprises a storage device of a machine type different from a machine type of the storage device in the terminal device, and the second model is a model generated on basis of the operating data on terminal devices which comprises a storage device of a same machine type as a machine type of the storage device in the terminal device.

17. The calculation device according to claim 14, wherein
the inspection request is a request to execute an inspection program for inspecting the storage device of the terminal device in the terminal device.

18. The calculation device according to claim 14, wherein
the storage device is a hard disk drive (HDD) or a solid state drive (SSD).

19. A model parameter calculation method executed by a processor, comprising:
comparing a first evaluation value with a second evaluation value wherein
the first evaluation value is calculated on basis of a first model and operating data of a terminal device, the first model represents relationship between at least one first parameter including at least one first variable and a first output variable regarding an occurrence possibility of a failure in the terminal device, the first variable being allocated with at least one feature based on operating data of the terminal device, and
the second evaluation value is calculated on basis of a second model and the operating data, the second model represents relationship between at least one second parameter including at least one second variable and a second output variable regarding the occurrence possibility of the failure in the terminal device, the second parameter being allocated with at least one feature based on the operating data;
transmitting an inspection request to inspect the terminal device to the terminal device or to a management device of the terminal device in accordance with a comparative relation between the first evaluation value and the second evaluation value; and
determining at least one third parameter included in a third model in accordance with a model reference of a predefined model type, on basis of an inspection result indicating an operating status of the terminal device and the operating data of the terminal device, wherein the third model represents relationship between the third parameter and a third output variable regarding the occurrence possibility of the failure in the terminal device, the third parameter includes at least one third variable being allocated with at least one feature based on the operating data.

20. A non-transitory computer readable medium having instructions stored therein which causes a processor to execute steps comprising:
comparing a first evaluation value with a second evaluation value wherein
the first evaluation value is calculated on basis of a first model and operating data of a terminal device, the first model represents relationship between at least one first parameter including at least one first variable and a first output variable regarding an occurrence possibility of a failure in the terminal device, the first variable being allocated with at least one feature based on operating data of the terminal device, and
the second evaluation value is calculated on basis of a second model and the operating data, the second model represents relationship between at least one second parameter including at least one second variable and a second output variable regarding the occurrence possibility of the failure in the terminal device, the second parameter being allocated with at least one feature based on the operating data;
transmitting an inspection request to inspect the terminal device to the terminal device or to a management device of the terminal device in accordance with a comparative relation between the first evaluation value and the second evaluation value; and
determining at least one third parameter included in a third model in accordance with a model reference of a predefined model type, on basis of an inspection result indicating an operating status of the terminal device and the operating data of the terminal device, wherein the third model represents relationship between the third parameter and a third output variable regarding the occurrence possibility of the failure in the terminal device, the third parameter includes at least one third variable being allocated with at least one feature based on the operating data.
